(19) United States
(12) Patent Application Publication
(10) Pub. No.: US 2007/0061326 A1
(43) Pub. Date: Mar. 15, 2007

(54) Receiving display station on a communication network for accessing and displaying network documents associated with a television program display in which the text stream of the TV program on the display station provides user selectable links to predetermined network source sites

(76) Inventors: Tyren J. Stading, Austin, TX (US); Rhys D. Ulerich, Austin, TX (US); Paul S. Williamson, Round Rock, TX (US); Scott L. Winters, Austin, TX (US)

Correspondence Address: IBM CORPORATION;INTELLECTUAL PROPERTY LAW, 11400 BURNET ROAD, AUSTIN, TX, 78758, US

(21) Appl. No.: 11/226,960

(22) Filed: Sep. 15, 2005

(51) Int. Cl. G06F 17/30

(52) U.S. Cl. 707/10

(57) ABSTRACT

An implementation comprising displaying to a user a presentation having sequences that correspond to spoken text that are not predeterminable, combined with predetermining a set of sites in a network based upon the anticipated interest of the user of the presentation and predetermining a set of key text terms respectively corresponding to the set of sites, the selection of which terms will link the user to one of the set of sites. There is an implementation for enabling the user to select the key text terms if the terms occur in said sequences of text, combined with linking the user to the site corresponding to the selected key text term. The displayed text sequence is a corresponding audio stream of a television program or presentation.

### TECHNICAL FIELD

The present invention relates to networks such as the World Wide Web (“Web”) for users at network display stations accessing data in the form of documents from database sources or sites maintained on the network, e.g. Web, and particularly to the linking of viewers of conventional television programming to predetermined network database sites.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet or Web. The convergence of the electronic entertainment and consumer industries with data processing exponentially accelerated the demand for wide ranging communication distribution channels, and the Web or Internet, which had quietly existed for over a generation as a loose academic and government data distribution facility, reached “critical mass” and commenced a period of phenomenal expansion. With this expansion, businesses and consumers have direct access to all matter of databases providing documents, media and computer programs through related distribution of Web documents, e.g. Web pages or electronic mail. Because of the ease with which documents are distributable via the Web, it has become a major source of data. Virtually all databases of public information throughout the world are accessible and able to be searched via the Web.

The ease with which great volumes of data may be searched from a computer attached to the Web and equipped with a Web browser has led to the development of widespread electronic commerce over the Web. At the present time, it is becoming very rare to find a business organization of any kind that does not transact some aspect of the business via the Web.

The consumer use of the Web or Internet for commerce, i.e. purchases of consumer products through the use of the users' personal computer connected to the Web via a Web browser has been increasing at a great pace. On the other hand, users of the Web in combination with the electronic entertainment business have been proceeding at a slower pace. Thus, both the electronic entertainment industry and the Web distribution industry are seeking new implementations by which the two giant industries may coact to commercial advantage. The present invention offers such an implementation.

Television is, of course, the mass electronic media. A small percentage of TV program viewers use their personal computers connected into the Web to supplement their TV viewing. When a topic arises on the TV presentation about which they would like more information, the users do a Web search on their ancillary personal computers to access such additional information. Thus, insofar as the hosts of the TV presentations are concerned, these ancillary searches are random and, although prompted by the content of the TV program, they provide no advertising or other commercial advantage to the hosts or sponsors of the TV presentations.

TV program hosts tried to take advantage of such ancillary viewer interest by making direct suggestions on their TV program of Web or like network sites that they recommend to the viewers for further information. While these ancillary Web sites maintained by the television presenters gave these presenters some additional viewer interest that would support additional advertising, and the like, and they had the limitation of user convenience. The viewer had to initiate a specific access request on his ancillary personal computer, and the Web sites, once accessed, were likely to offer very general information that might not be specific enough for the viewer's interest.

### SUMMARY OF THE PRESENT INVENTION

The present invention provides a system involving the use of a personal computer operating as a network display station ancillary to TV program display apparatus wherein the ancillary display station and the TV display apparatus are so tightly coupled that the network or Web site is content specific to the user's needs and interest, and effort required on the part of the user is minimal.

The present invention provides an implementation comprising means for displaying to the user a presentation having sequences of spoken text that are not predeterminable, combined with means for predetermining a set of sites in the network based upon anticipated interests of the user of the presentation, and means for predetermining a set of key text terms respectively corresponding to the set of sites, the selection of which terms will link the user to one of the set of sites. There are means for enabling the user to select the key text terms if the terms occur in the sequence of text, combined with means for linking the user to the site corresponding to the selected key text term. The invention may be most effectively used if the displayed text sequence represents the audio stream of a television presentation, e.g. TV show that is displayed on a TV set separate from the receiving display station and showing the closed captioned text.

For best results, there may be an implementation comprising highlighting the key text terms in the sequences of text and enabling the user to point to the highlighted terms. In addition, there may be displayed a preview of a linked network site document on the display station concurrently with the highlighting of the key text term corresponding to the link network site.

In accordance with another aspect of the present invention, there may be displayed to the user a plurality of presentations, each having unpredeterminable sequences of text, followed by the combination of predetermining a plurality of sets of sites in the network based upon anticipated interest of the user in each of the presentations, predetermining a plurality of sets of key text terms respectively corresponding to the sets of sites, the selection of one of which terms will link the user to a corresponding one of the set of sites, and enabling the user to select the key text terms if the terms occur in the sequences of text to thereby link the user to the site corresponding to the selected term. Further, the user may be enabled to continue to display a document accessed during one of the plurality of presentations during another subsequent presentation.

It has been noted hereinabove that the present invention is most effective when the presentation being text streamed has an unpredetermined, e.g. live, broadcast text stream. However, in the embodiment involving multiple presentations, one of the presentations should have a predetermined text stream.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of a network, e.g. Web portion, to illustrate how the TV program in the present invention may be text streamed on an ancillary computer display station on the Web so that highlighted terms in the text stream may act as selectable links to a plurality of predetermined Web sites;

FIG. 2 is a block diagram of a data processing system including a central processing unit and network connections via a communications adapter that is capable of functioning both as a server computer and a receiving computer display station on the Web portion of FIG. 1;

FIG. 3 is an illustrative receiving computer display station showing the text stream for the corresponding TV program with key terms highlighted to serve as selectable links;

FIG. 4 is the illustrative receiving computer display station of FIG. 3 but in an alternative embodiment wherein each highlighted key term link shown is accompanied by a preview of the Web site document to be accessed and displayed if the link is selected;

FIG. 5 is an illustrative flowchart describing the setting up of the elements of the present invention for text streaming of a TV program on an ancillary computer display station on the Web so that highlighted terms in the text stream may act as selectable links to a plurality of predetermined Web sites; and

FIG. 6 is a flowchart of an illustrative run of the text streaming program set up in FIG. 5.

### DETAILED DESCRIPTION OF THE PREFERRED EMBODIMENT

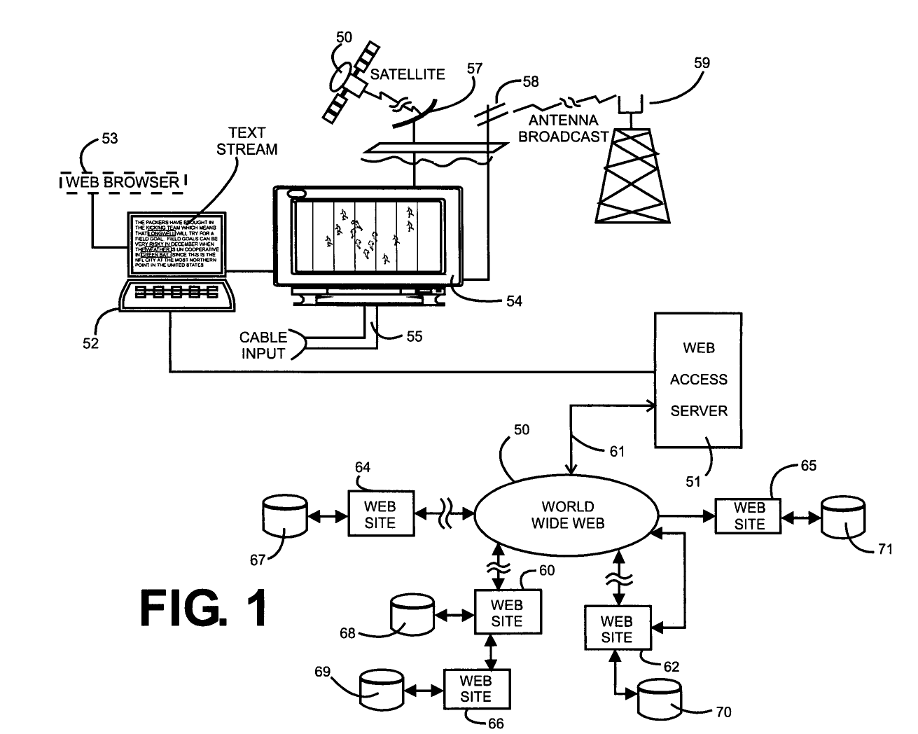

Referring to FIG. 1, there is shown a very generalized diagram of an illustrative Web portion with a group of predetermined Web sites 60, 62, 64 and 65, each with an associated database 68, 70, 67 and 71. These have been predetermined by the television program or presentation host as being sites of anticipated interest to viewers of the television presentation on TV display 54. The TV program could be input to the conventional TV display 54 by any standard input: normal broadcast from antenna 59 to antenna 58; cable input 55; or input from satellite 56 through dish antenna 58. However, the operation is most effective when the text to be spoken during the presentation will be streamed in the conventional manner by which text has been streamed for decades as closed captioned text for the hearing impaired. However, instead of the text stream on the TV display, it is connected to and displayed on a separate personal computer 52 or similar Web station of the user. The linkage between the television display set may be any convention linkage. In an embodiment wherein the television has a current state of the art digital display format, any closed captioned text stream displayable on television display 54 could be connected to the display of computer 52 by direct connection as shown or by any standard RF wireless connection.

As will be hereinafter described in greater detail, the host of a live presentation, e.g. a news or sports presentation, cannot predetermine the exact sequence of text in the audio text stream but can anticipate most of the terms that are likely to be used. For example, if the presentation is a sporting event, such as a baseball game, he knows that most of the participating players are likely to be mentioned. Also, many types of statistics are likely to be mentioned, or many baseball teams are likely to be mentioned. Thus, the host makes all of these potential terms links so that when they appear in the data stream and are selected by the user, the user is linked to one of the predetermined Web sites that the host wishes to link for advertising and other commercial purposes. When the user selects such a term in the data stream on computer 52, under the control of Web browser 53 in computer 52, the appropriate Web site 60, 62, 64 or 65 is accessed via Web 50 through Web Access Server 51 and displayed on personal computer 52.

While this illustration has described the invention with respect to the Web, the present invention may be implemented on any appropriate network for handling requests from a receiving network display station for information documents from other network sites. In the current example, computer 52 controlled by a conventional Web browser program 53 is typically connected to the Web 50 via standard Web wired connections 61 through Web access server 51 that may be provided by a commercial service provider. Reference may be made to the text, Mastering the Internet, G. H. Cady et al., published by Sybex Inc., Alameda, Calif., 1996, particularly pp. 136-147, for typical connections between receiving display stations to the Web 50 via access server 51 through connection 61.

Before going further into the details of specific embodiments, it will be helpful to understand from a more general perspective the various elements and methods that may be related to the present invention. Since an aspect of the present invention is directed to Web documents, such as Web pages, transmitted over networks, an understanding of networks and their operating principles would be helpful. We will not go into great detail in describing the networks to which the present invention is applicable. The Internet or Web is a global network of a heterogeneous mix of computer technologies and operating systems. Objects are linked to other objects in the hierarchy through a variety of network server computers. These network servers are the key to network distribution, such as the distribution of Web pages and related documentation. In this connection, the term “documents” is used to describe data transmitted over the Web or other networks and is intended to include Web pages with displayable text, graphics and other images.

Web documents are conventionally implemented in a markup language such as HTML, which is described in detail in the text entitled Just Java, Peter van der Linden, 2nd Ed., Sun Microsystems Inc, Mountain View Calif., 1997 particularly at Chapter 7, pp. 249-268, dealing with the handling of Web pages; and also in the aforementioned text Mastering the Internet, particularly at pp. 637-642, on HTML in the formation of Web pages.

In addition, aspects of this invention will involve Web browsers. A general and comprehensive description of browsers may be found in the above-mentioned Mastering the Internet text at pp. 291-313. More detailed browser descriptions may be found in the Internet: The Complete Reference, Millennium Edition text, Margaret Young, Osborne McGraw-Hill, Berkley Calif., 1999: Chapter 20, pp. 455-494, on the Microsoft Internet Explorer; and Chapter 21, pp. 495-512, covering Lynx, Opera and other browsers.

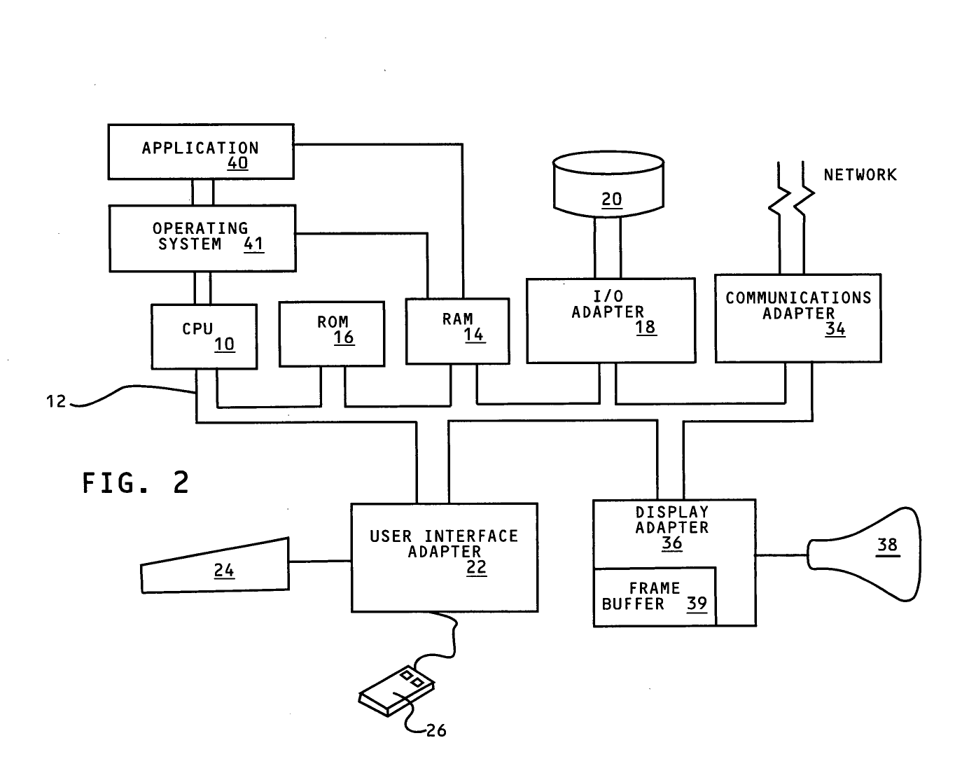

Referring to FIG. 2, a typical data processing unit is shown that may function as the receiving or client display station computer 52 for receiving the Web documents from Web sites, and for appropriately displaying the closed captioned text of the audio data streams from the corresponding programs on the TV set. A central processing unit (CPU) 10, such as one of the PC microprocessors or workstations, e.g. eServer pSeries available from International Business Machines Corporation (IBM) or Dell PC microprocessors, is provided and interconnected to various other components by system bus 12. An operating system 41 runs on CPU 10, provides control and is used to coordinate the function of the various components of the computer of FIG. 2. Operating system 41 may be one of the commercially available operating systems, such as IBM's AIX or Microsoft's WindowsXP™, as well as UNIX and other IBM AIX operating systems. Application programs 40, controlled by the system, are moved into and out of the main memory Random Access Memory (RAM) 14. These programs include the programs of the present invention for displaying the TV program's audio text data stream on computer 52 with appropriate predetermined keyword links to predetermined Web sites. These functions will be described hereinafter in combination with conventional Web browsers (browser 53, FIG. 1) at client computer 52, such as Microsoft's Internet Explorer™. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside network, e.g. Web. I/O devices are also connected to system bus 12 via user interface adapter 22 and display adapter 36. Keyboard 24 and mouse 26 are all interconnected to bus 12 through user interface adapter 22. It is through such input devices that the user at the computer 52 may interactively select appropriate links in the displayed text stream to the Web sites predetermined by the TV program host.

Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

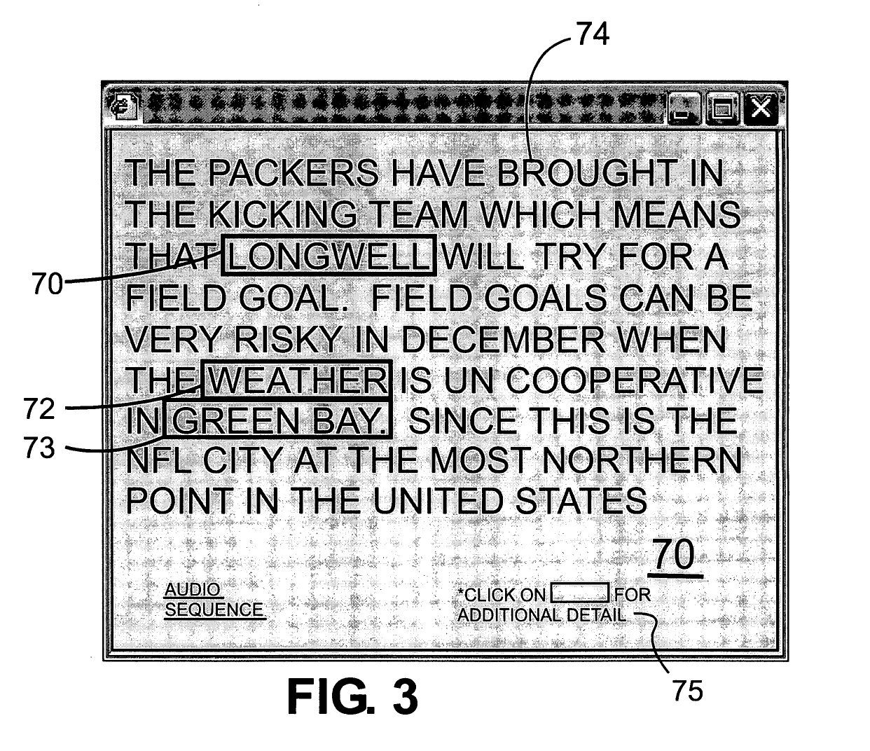

Now, with respect to FIG. 3, a simple illustration will be shown of how the present invention functions. In the example, we are dealing with a live TV presentation of a football game involving the Green Bay Packers on a very cold day. The host, in planning his links to Web sites to which he wishes to direct users, does not know exactly what the announcers whose audio is being text streamed on the computer display will say but he can anticipate that the announcer will at least mention players, teams and the weather. Thus, the host selects Web sites advantageous to and that the host wishes to direct the users requesting ancillary data and creates a set of keyword terms, the selection of which will be links to the host's desired Web sites, e.g. keywords 71, 72 and 73 in text stream 74 on computer display 70. The user is prompted 75 to click on specific keywords if he wishes to get further information in the form of documents from Web sites. In this manner, the user desiring ancillary information is led to Web sites that are advantageous to the host of the TV presentation. In the example shown, the keywords are highlighted. They need not be highlighted. In an alternate embodiment, the keywords are not highlighted. The user is prompted to select any word of interest to him in the data stream. If the user then selects a key text term, he is connected to the Web site predetermined by the host to correspond to the key text term. If the selected word is not a key text term, then an implementation may be set up to do a routine keyword search for the Web and display the results to the user. This keyword search may be directed to a search database predetermined by the host.

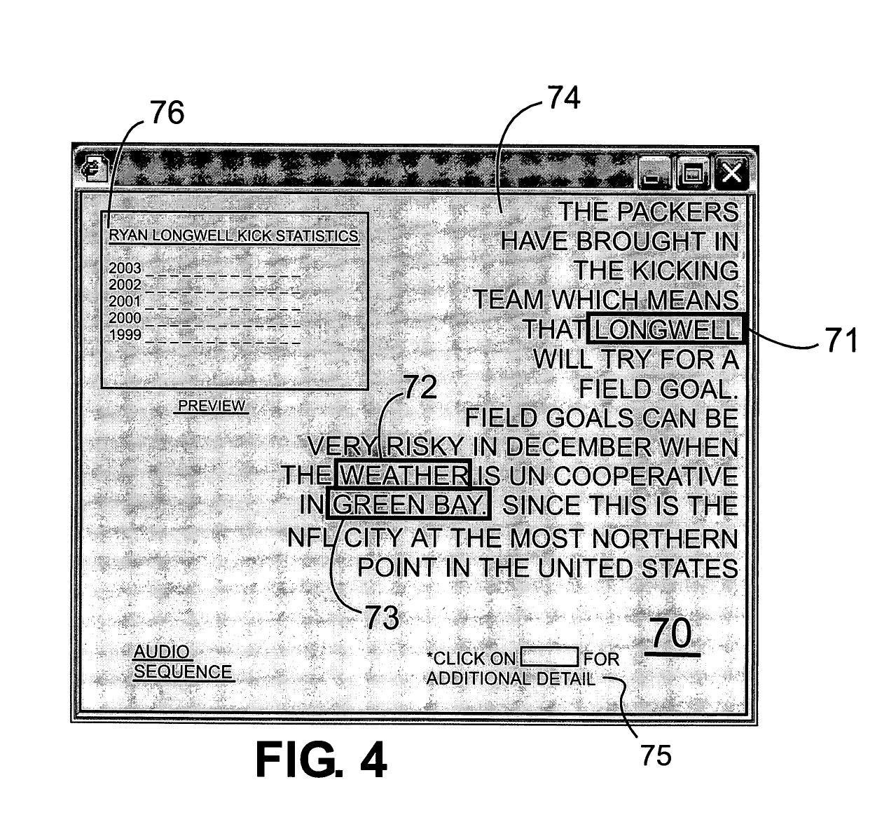

In an alternate embodiment in FIG. 4, as the text stream 74 sequentially moves along and the highlighted key terms 71 through 73 are displayed, the browser is programmed to fetch from the Web and render a representative preview 76 of the Web document. This may provide some further incentive for the user to select the keyword link and retrieve the document. The process may be set up so that the preview remains open so long as the keyword link still appears in the data stream 74 or for a predetermined period of time after the keyword or term first appeared. When, the keyword streams out of the display or time expires, the preview window may be removed. It should be understood that if even two or three keywords are being displayed on the computer display, two or three corresponding preview windows may be displayed and even overlapped or otherwise arranged if necessary.

FIG. 4 is a flowchart showing the development of a process according to the present invention for the setting up of the elements of the present invention for closed captioned text streaming of a TV program on an ancillary computer display station on the Web so that highlighted terms in the text stream may act as selectable links to a plurality of predetermined Web sites. Thus, in association with the broadcast of a television program presentation having a live content of sequential audible text that cannot be predetermined, provision is made for the display of a stream of text on a network, e.g. Web display station, associated with TV program display, step 80. Provision is made for enabling the TV presentation host to predetermine a set of network sites of anticipated interest to the users, i.e. television viewers, step 81. Provision is also made for enabling the TV presentation host to determine a set of key spoken terms respectively corresponding to each of the set of sites, step 82. Provision is made for the highlighting of each of the key text terms in the predetermined set as that term may randomly appear in the text stream, step 83. Provision is made to enable a user at the display station to select a highlighted term to thereby link the user to the corresponding network site, step 84. Provision may then be made for a response when the user selects a term in the text stream that is not in the set of predetermined key text terms. The response provides for a search for network sites related to the selected term, step 85. The response may be preconfigured by the host or broadcaster to cover databases that will provide hits favorable to the host or broadcaster. Provision may also be made for the presentation of a plurality of television programs in sequence in which each television program has its own set of predetermined spoken terms, independent of the other sets of spoken terms, linked to sites of interest, step 86. Finally provision may be made for displaying a preview of a document from one of a set of predetermined sites simultaneously with the display in the text of a highlighted link to the site, step 87.

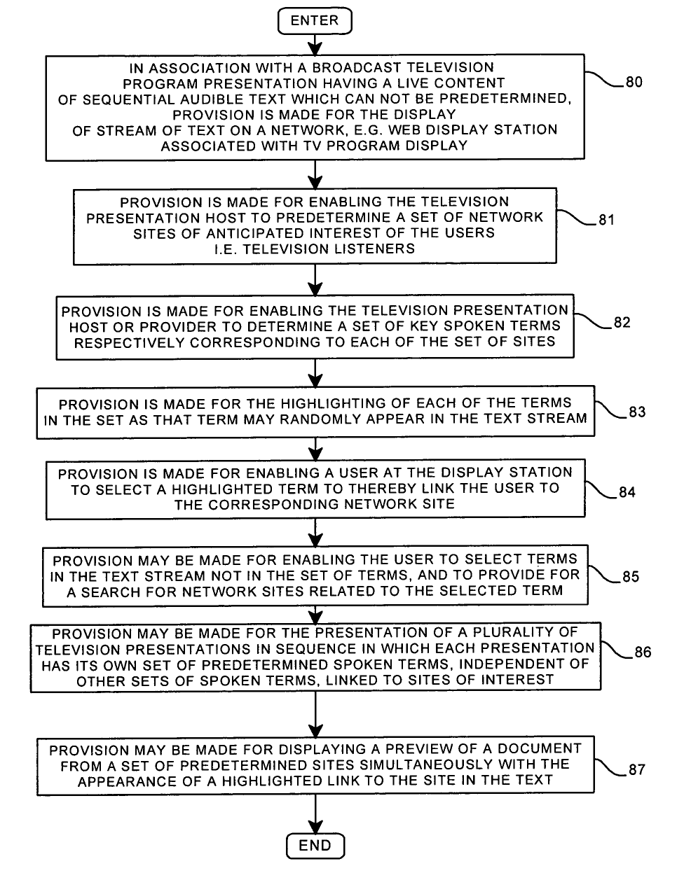

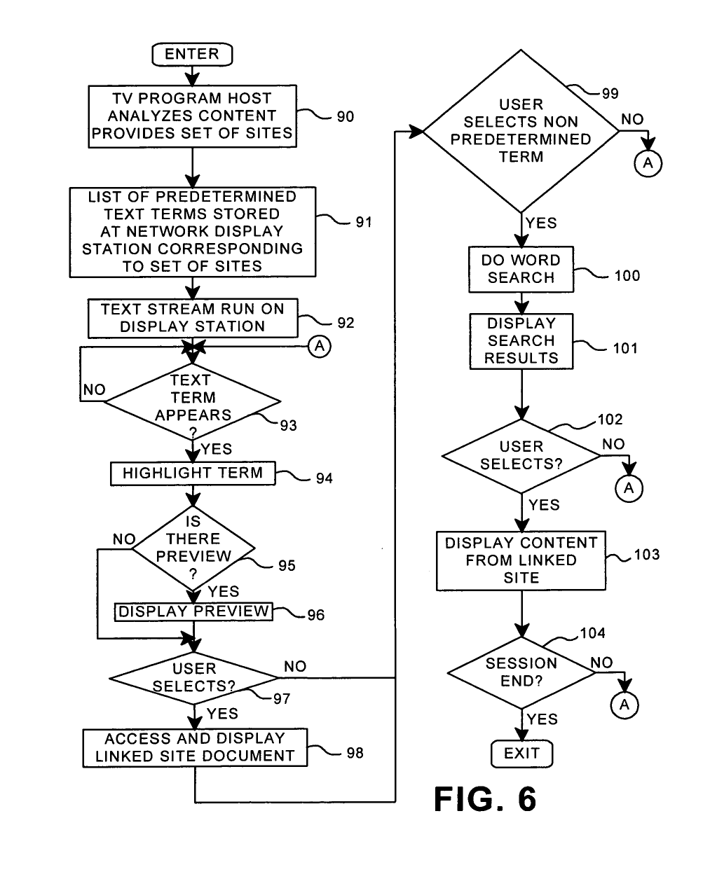

The running of the process set up in FIG. 5 will now be described with respect to the flowchart of FIG. 6. Since this is merely an illustrative run, all of the processes and variations discussed hereinabove may not be illustrated. Initially, the hosts of the TV presentation provide a set of Web sites to which the hosts expect to be able to direct interested users so that the host may get advertising revenue and other potential commercial advantages, step 90. The host knows what the general content of the TV presentation is, but he does not know what the specific content of the audio stream will be. Thus, the host will be able to anticipate that particular terms are likely to be used in the audio stream that will be displayed on the computer display in describing the live TV presentation. In step 91, these likely terms to be transmitted and stored at the computer display station with a respectively corresponding set of the Web sites selected by the host for his commercial interests. This text stream is then run on the display station, step 92, simultaneously with the television program of which it is the audio.

With the text streaming as described, a determination is continually made, step 93, as to whether a text term appears that is a stored key text term. If Yes, the term is highlighted, step 94. Then, step 95, a determination is made as to whether a preview is to be displayed along with the corresponding highlighted key text term. If Yes, the preview is displayed, step 96. If No, the preview is not displayed. Then, a determination is made, step 97, as to whether a user has selected a highlighted key text term. If Yes, the predetermined site Web document corresponding to the key text term is accessed and displayed, step 98. At this point, a further determination may be made, step 99, as to whether the user has selected a term from the displayed text stream that is not one of the predetermined terms. If No, the process is branched back to step 93 via branch “A”. If Yes, a word search is done on the nonpredetermined term using the databases found to be advantageous to the broadcaster or host, step 100, and the search results are displayed, step 101. Then, step 102, a determination is made as to whether the user has selected a Web site from the search. If Yes, and appropriate Web document is accessed from its site and displayed, step 103. Instead of a Web document, an audio file from the Web site may be rendered or a video clip rendered. If No, the process is branched back to step 93 via branch “A”.

Finally, a determination may be made at this point as to whether the session is ended, step 104. If Yes, the session is exited. If No, the process is branched back to step 93 via branch “A”.

In accordance with another aspect of the present invention, a scroll capability may be provided wherein the text stream may be buffered with the capability of enabling the user to select a previously displayed text term from a previously displayed text stream.

As set forth above, the implementations of the present invention may include the presentation of a plurality of television programs in sequence in which each program in the sequence has its own set of predetermined set of sites of interest together with its own set of corresponding key text terms, which, when appearing in the text stream, link the user to the respective corresponding Web site. In such a multiple presentation arrangement, it is possible that the same term when appearing in text streams of different television program presentations could be treated as different key text terms corresponding to different predetermined Web sites. Also, in such multi-presentation arrangements, a user could be enabled to retain the display of a Web or other network document during a subsequent TV presentation even if the displayed Web document was brought up on the computer station display during an earlier TV program or presentation.

In accordance with another aspect of the present invention, the selected language of the closed captioning of the TV program is transmitted to the user's computer display in a streaming text format such that any selectable key text term (hyperlink) is in the same language as the language of the text stream, and the predetermined Web sites should also be in the same language. The same principles would be applicable with respect to any searches done on the above described terms that are not predetermined key text terms. These databases should provide output in the language of the text stream.

In this specification when reference is made to a text data stream, it should be understood that the term text is intended to apply to any numerals or symbols that may be included in a closed captioned data stream.

One of the preferred implementations of the present invention is in application program 40, i.e. a browser program, made up of programming steps or instructions resident in RAM 14, FIG. 2, of a client display station and/or server during various operations. Until required by the computer system, the program instructions may be stored in another readable medium, e.g. in disk drive 20 or in a removable memory, such as an optical disk for use in a CD ROM computer input or in a floppy disk for use in a floppy disk drive computer input. Further, the program instructions may be stored in the memory of another computer prior to use in the system of the present invention and transmitted over a network such as the Web itself, when required by the user of the present invention.

One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

1. In a communication network with user access via a plurality of data processor controlled interactive receiving display stations for displaying received documents accessible from sites in the network, method for linking a user at a receiving display station to predetermined network sites comprising:
displaying to said user a presentation having sequences of text;
predetermining a set of sites in said network based upon anticipated interest of said user of said presentation;
predetermining a set of key text terms respectively corresponding to said set of sites, the selection of which terms will link the user to one of said set of sites; and
enabling the user to select said key text terms if said terms occur in said sequences of text to thereby link the user to the site corresponding to the selected term.

2. The method of claim 1 further including the step, responsive to the selection by said user of a term in said sequences of text other than a key text term, of carrying out a network search based on said other text term in a predetermined set of searchable databases.

3. The method of claim 1 wherein said presentation is a live television presentation in which the displayed text sequence is the text that represents the audio stream of said television presentation.

4. The method of claim 3 wherein said live television presentation is presented separate from said receiving display station while the text that represents said audio stream is displayed at said display station.

5. The method of claim 2 wherein said presentation is a live television presentation in which the displayed text sequence is the text that represents the audio stream of said television presentation.

6. The method of claim 5 wherein said live television is presented separate from said receiving display station while the text that represents said audio stream is displayed at said display station.

7. The method of claim 4 wherein said communication network is the World Wide Web (“Web”), said sites are Web sites, and further including the step of accessing Web documents at said receiving station from linked Web sites.

8. The method of claim 1 wherein said step of enabling the user to select said key text terms comprises:
highlighting the key text terms in said sequences of text; and
enabling the user to point to said highlighted terms.

9. The method of claim 8 further including the step of displaying a preview of a linked network site document on the display station concurrently with the highlighting of the key text term corresponding to the link network site.

10. In a communication network with user access via a plurality of data processor controlled interactive receiving display stations for displaying received documents accessible from sites in the network, a method for linking a user at a receiving display station to predetermined network sites comprising:
displaying to said user a plurality of presentations, each having sequences of text;
predetermining a plurality of sets of sites in said network based upon anticipated interest of said user in each of said presentations;
predetermining a plurality of sets of key text terms respectively corresponding to said sets of sites, the selection of one of which terms will link the user to a corresponding one of said set of sites; and
enabling the user to select said key text terms if said terms occur in said sequences of text to thereby link the user to the site corresponding to the selected term.

11. The method of claim 10 further including the step of enabling a user to access and display a document from a linked site on said receiving display station.

12. The method of claim 11 further including the step of enabling said user to continue to display a document accessed during one of said plurality of presentations during another subsequent presentation.

13. The method of claim 11 wherein said plurality of presentations further includes at least one presentation having predetermined sequences of text.

14. The method of claim 13 wherein at least one of said predetermined key text terms functions as a key text term in a plurality of said presentations.

15. In a communication network with user access via a plurality of data processor controlled interactive receiving display stations for displaying received documents accessible from sites in the network, a system for linking a user at a receiving display station to predetermined network sites comprising:
means for displaying to said user a presentation having sequences of text:
means for predetermining a set of sites in said network based upon anticipated interest of said user of said presentation;
means for predetermining a set of key text terms respectively corresponding to said set of sites, the selection of which terms will link the user to one of said set of sites;
means for enabling the user to select said key text terms if said terms occur in said sequences of text; and
means for linking the user to the site corresponding to the selected key text term.

16. The system of claim 15 further including:
means, responsive to the selection by said user of a term in said sequence of text other than a key text term, for carrying out a network search based on said other text term in a predetermined set of searchable databases.

17. The system of claim 15 wherein said presentation is a live television presentation in which the displayed text sequence is the text that represents the audio stream of said television presentation.

18. The system of claim 17 wherein said live television is presented separate from said receiving display station while the text that represents said audio stream is displayed at said display station.

19. The system of claim 16 wherein said presentation is a live television presentation in which the displayed text sequence represents the audio stream of said television presentation.

20. The system of claim 19 wherein said live television is presented separate from said receiving display station while the text that represents said audio stream is displayed at said display station.

21. The system of claim 18 wherein:
said communication network is the Web, said sites are Web sites; and
further including means for accessing Web documents at said receiving station from linked Web sites.

22. The system of claim 15 wherein said means for enabling the user to select said key text terms comprises:
means for highlighting the key text terms in said sequences of text; and
means for enabling the user to select said highlighted terms.

23. The system of claim 22 further including means for displaying a preview of a linked network site document on the display station concurrently with the highlighting of the key text term corresponding to the link network site.

24. In a communication network with user access via a plurality of data processor controlled interactive receiving display stations for displaying received documents accessible from sites in the network, a system for linking a user at a receiving display station to predetermined network sites comprising:
means for displaying to said user a plurality of presentations, each having sequences of text;
means for predetermining a plurality of sets of sites in said network based upon anticipated interest of said user in each of said presentations;
means for predetermining a plurality of sets of key text terms respectively corresponding to said sets of sites, the selection of one of which terms will link the user to a corresponding one of said set of sites;
means for enabling the user to select said key text terms if said terms occur in said sequences of text; and
means for linking the user to the site corresponding to the selected key text term.

25. The system of claim 24 further including means for enabling a user to access and display a document from a linked site an said receiving display station.

26. The system of claim 25 further including means for enabling said user to continue to display a document accessed during one of said plurality of presentations during another subsequent presentation.

27. The system of claim 25 wherein said plurality of presentations further includes at least one presentation having predetermined sequences of text.

28. The system of claim 27 wherein at least one of said predetermined key text terms functions as a key text term in a plurality of said presentations.

29. A computer program having code recorded on a computer readable medium for linking a user at a receiving display station to predetermined network sites in a communication network with user access via a plurality of data processor controlled interactive receiving display stations for displaying-received documents accessible from sites in the network, said program comprising:
means for displaying to said user a presentation having sequences of text;
means for predetermining a set of sites in said network based upon anticipated interest of said user of said presentation;
means for predetermining a set of key text terms respectively corresponding to said set of sites, the selection of which terms will link the user to one of said set of sites;
means for enabling the user to select said key text terms if said terms occur in said sequences of text; and
means for linking the user to the site corresponding to the selected key text term.

30. The computer program of claim 29 further including:
means, responsive to the selection by said user of a term in said sequences of text other than a key text term, for carrying out a network search based on said other text term in a predetermined set of searchable databases.

31. The computer program of claim 29 wherein said presentation is a live television presentation in which the displayed text sequence is the audio stream of said television presentation.

32. The computer program of claim 31 wherein said live television presentation is presented separate from said receiving display station while the text that represents said audio stream is displayed at said display station.

33. The computer program of claim 30 wherein said presentation is a live television presentation in which the displayed text sequence is the text that represents the audio stream of said television presentation.

34. The computer program of claim 33 wherein said live television is presented separate from said receiving display station while the text that represents said audio stream is displayed at said display station.

35. The computer program of claim 32 wherein:
said communication network is the Web, said sites are Web sites; and
further including means for accessing Web documents at said receiving station from linked Web sites.

36. The computer program of claim 32 wherein said means for enabling the user to select said key text terms comprises:
means for highlighting the key text terms in said sequences of text; and
means for enabling the user to select said highlighted terms.

37. The computer program of claim 36 further including means for displaying a preview of a linked network site document on the display station concurrently with the highlighting of the key text term corresponding to the link network site.

38. A computer program having code recorded on a computer readable medium for linking a user at a receiving display station to predetermined network sites in a communication network with user access via a plurality of data processor controlled interactive receiving display stations for displaying received documents accessible from sites in the network, said computer program comprising:
means for displaying to said user a plurality of presentations, each having sequences of text;
means for predetermining a plurality of sets of sites in said network based upon the anticipated interest of said user in each of said presentations:
means for predetermining a plurality of sets of key text terms respectively corresponding to said sets of sites, the selection of one of which terms will link the user to a corresponding one of said set of sites;
means for enabling the user to select said key text terms if said terms occur in said sequences of text; and
means for linking the user to the site corresponding to the selected key text term.

39. The computer program of claim 38 further including means for enabling a user to access and display a document from a linked site on said receiving display station.

40. The computer program of claim 39 further including means for enabling said user to continue to display a document accessed during one of said plurality of presentations during another subsequent presentation.

41. The computer program of claim 39 wherein said plurality of presentations further includes at least one presentation having predetermined sequences of text.

42. The computer program of claim 41 wherein at least one of said predetermined key text terms functions as a key text term in a plurality of said presentations.
